(19) United States
(12) Patent Application Publication
(10) Pub. No.: US 2026/0091327 A1
(43) Pub. Date: Apr. 2, 2026

(54) FLEXIBLE END CAP FOR CERAMIC FLAT FILTERS

(71) Applicant: CERAFILTEC GERMANY GMBH, Saarbruecken (DE)

(72) Inventors: Gabriele TERBAHL, Saarbruecken (DE); Martin KASCHEK, Ingbert (DE); Kay Gunther GABRIEL, Saarbruecken (DE)

(73) Assignee: CERAFILTEC GERMANY GMBH, Saarbruecken (DE)

(21) Appl. No.: 19/409,354

(22) Filed: Dec. 4, 2025

Related U.S. Application Data
(63) Continuation of application No. PCT/EP2024/064749, filed on May 29, 2024.

(30) Foreign Application Priority Data
Jun. 7, 2023 (DE) 10 2023 115 044.8

(51) Int. Cl. B01D 29/03; B01D 29/01; B01D 39/20

(52) U.S. Cl. CPC B01D 29/03; B01D 29/012; B01D 39/2068; B01D 2201/291; B01D 2201/347

(57) ABSTRACT

A method radially seals a ceramic flat filter with a flexible end cap. A set used for sealing has a ceramic flat filter, a flexible end cap and an adhesive. The filter has two axial end faces and radial side faces and interior filtrate channels extend along the flat filter plane and open into at least one end face. The end cap is mountable on an end region of the filter and is permanently fastened to the filter by the adhesive and has at least one filtrate outlet collection channel. Filtrate supplied from the channels of the filter is collectable in the collection channel in the mounted state and is forwardable to the outlet. The end cap is formed from elastic material and has a recess which, when expanded, can receive an insertion region of the filter and when not expanded, has a width no larger than the insertion region.

### CROSS REFERENCE TO RELATED APPLICATIONS

This application is a continuation under 35 U.S.C. § 120 of International Application PCT/EP2024/064749, filed May 29, 2024, which claims priority to German Application No. 10 2023 115 044.8, filed Jun. 7, 2023, the contents of each of which are incorporated by reference herein in their entirety.

### FIELD OF THE INVENTION

The present invention relates to a method for radially sealing a ceramic flat filter with a flexible end cap, a set used for this purpose of a ceramic flat filter, a flexible end cap and an adhesive as well as the flexible end cap itself.

### BACKGROUND

Ceramic flat filters have become established over the last 20 years as so-called fine filters in water and waste water treatment. In this case, fine filters are typically used within sewage treatment plants following the post-clarification basin in order to reliably separate microorganisms and other organic material. In the present case, a fine filter is to be understood as meaning those filters which have a sufficiently small pore size in order to retain microorganisms during the filtration process. Depending on the pore size, such fine filters are frequently also referred to as microfilters, ultrafilters, nanofilters or the like.

Ceramic flat filters are produced worldwide in various porous ceramic materials by various manufacturers. Ceramic flat filters 1 usually have the plate-shaped basic design illustrated in FIGS. 1A (oblique view) and 1B (front view). The flat filter 1 has an outer side 2 (feed side), which is formed by radial side surfaces and has rounded edges and on which the liquid to be filtered impinges. A plurality of filtrate channels 3 extend in the interior of the flat filter 1 and open into (at least) one axial end face 4 of the flat filter 1. The surface of the filtrate channels 3 is also referred to here as the inner side of the filter. The liquid to be filtered is in contact with the radial side faces 2 of the outer side, enters the interior of the filter through the pores of the ceramic, reaches the filtrate channels 3 provided there and is discharged from the flat filter 1 via these at the end faces. Ceramic flat filters typically have a longitudinal extent of approximately 150 to 1000 mm. The axial end faces of the ceramic flat filter usually extend over a width of 80 to 300 mm and a thickness of 3 to 8 mm.

The filtered-off solids are deposited here as a filter cake on the outer side of the flat filter. If the deposits reach a certain thickness, they are typically removed by means of the so-called backwashing process. In this case, a clean liquid is pressed under pressure into the filtrate channels and flushed through the ceramic of the filter to the outer surface. There, the liquid entrains deposits located on the outer surface and thus ensures cleaning of the radial side faces of the filter.

In order that the liquid to be filtered does not mix with the filtrate, the outer side (feed side) has to be sealed off from the inner side, so that filtration through the flat filter from the outside to the inside to the filtrate channels is made possible. If the filtrate channels open into both end faces of the flat filter, which is frequently the case owing to the extrusion production process of the ceramic flat filters, such a seal is required on both end faces of the flat filter.

This seal on the end faces has hitherto typically been realized in the prior art by means of two different approaches.

In the first approach illustrated in FIGS. 2A-C, the ceramic flat filter 1 is inserted in an end-face insertion region 5 into a recess 6 of a dimensionally stable end cap 7 and then connected to the end cap 7 by means of a potting adhesive bond 8. The insertion depth of the flat filter into the end cap is usually 5 to 15 mm. The end cap is typically formed from a hard plastic, for example PES, PVC, ABS, from glass-fiber-reinforced plastic materials, ceramics or metals.

In addition to the seal, the end cap often also has the function of collecting the filtered water from the filtrate channels of the flat filter and discharging it via an outflow to a large collector, for example a pipe, hose or module housing. The gap-shaped recess of the end cap (which is also referred to as the inner gap of the end cap) is in each case greater in its width (longitudinal extent) and in its thickness (transverse extent) than the outer dimension of the flat filter in the insertion region. The longitudinal extent and the transverse extent of the gap-shaped recess define the clear width of the recess. The outer width or outer thickness of the axial end faces of the flat filter are therefore smaller than the longitudinal extent or the transverse extent of the recess of the end cap. The flat filter can therefore be inserted into the recess of the end cap without the inner wall of the recess coming into contact with the radial side walls of the flat filter. In other words, the inner wall of the recess and the radial side walls of the flat filter do not come into contact when the flat filter is inserted into the recess.

The recess of the end cap therefore has a clear width which is characterized by an oversize in terms of width (longitudinal extent) and thickness (transverse extent) in comparison with the outer dimension of the flat filter in the insertion region. This results in an open gap between the inner wall of the recess of the end cap and the radial side faces of the flat filter, the gap width usually being 0.7 to 1.5 mm. This open gap is typically closed with a potting adhesive. The functions of the potting adhesive in this case are the filling of the gap (potting) in order to enable the seal, and the fixing (adhesive bonding) of the end cap and of the flat filter to one another, with the result that a permanently firm connection is formed which cannot be released.

The permanently firm connection of flat filter and end cap in this case also has to be ensured, in particular, during the backflushing phases when liquid is pressed under pressure into the filtrate channels on account of the forced flow reversal.

Flowable masses, for example composed of epoxy resin or polyurethane, are typically used as potting adhesive. The flowable masses are introduced into the open gap via the adhesive introduction point according to the gravity casting method, that is to say flow into the gap depth due to gravity and therefore fill the complete gap space (inflow phase). The potting adhesive then has to cure (curing phase). Before a second end cap can be mounted on the opposite end face of the flat filter, it is accordingly necessary to wait for the inflow phase and the curing phase of the potting compound in the case of the first end cap. Otherwise, during the associated rearrangement of the flat filter, the potting compound would flow out of the gap of the first end cap again. The finished unit consists of three components: the flat filter, the cured potting adhesive and the end cap. Such a sealing principle is described, for example, in the document WO 2007 128 565 A2.

The second potting approach is described, for example, in the document WO 2010 015 374 A1. It is the same as the approach described above that flowable masses, for example composed of epoxy resin or polyurethane, which are introduced into the open gap, flow gravitationally into the gap depth and fill the complete gap space, are likewise used according to the gravity casting method.

The difference of this potting approach consists in that an end cap is dispensed with. Instead, the potting adhesive additionally assumes the function of the end cap, which means that the potting not only fills an open gap, but is also brought into a shape which makes it possible to collect the filtered water from the filtrate channels of the flat filter and discharge it via an outflow to a large collector, for example a pipe, hose or module housing. In order to be able to dispense with the end cap, the cured potting adhesive has to be sufficiently dimensionally stable. The finished unit therefore consists of only two components: the flat filter and the cured, dimensionally stable potting adhesive. For the production of the finished unit, instead of an end cap, a potting mold is used which, by virtue of its inner dimensions, determines the outer dimensions of the cured potting adhesive.

In order to avoid the potting adhesive also sticking to the potting mold, mold release agents such as, for example, silicone oil are used. For this purpose, before the start of potting, the potting mold is wetted with the mold release agent on all of its inner sides. After the potting adhesive has cured, it sticks firmly to the flat filter, but not to the potting mold (previously wetted with the release agent). The potting mold is removed from the cured potting adhesive in the so-called demolding step and then usually used again for further moldings. The potting mold is therefore a tool part of production which can be reused.

Both approaches have the common disadvantage that they are based on a gravity casting method (gravity potting method). A gravitationally flowable mass is therefore required as potting adhesive. End cap and flat filter therefore have to be positioned during the potting method in such a way that the flowable mass can flow into the gap and fill it as a result of gravity. Simultaneous potting of two end caps attached to opposite end faces of the flat filter is therefore not feasible. With the potting of the second end cap, it is necessary to wait until the flowable mass in the first end cap has cured to such an extent that it does not run out of the filled gap again by 180° even after the required rearrangement of the flat filter. Production is therefore quite time-consuming.

Owing to the plate-shaped geometry and the relatively large geometric manufacturing tolerances of the flat filter, it has hitherto not been possible to realize a conventional seal by means of a rubber seal in the form of a sealing ring or another shaped seal as a radial or axial sealing principle with an enclosing housing. This sealing principle is used, for example, in ceramic round filters in which, as a result of a low manufacturing tolerance, the (relatively) exactly circular outer shape of the filter presses an inserted seal uniformly over the sealing housing and therefore permits permanently reliable sealing. For the successful use of this sealing principle, geometric manufacturing tolerances of a few 1/10 mm are usually required. However, ceramic flat filters usually have significantly larger geometric manufacturing tolerances of up to 1 mm. For this reason, only sealing principles have hitherto been realized by means of a potting compound, since the flowable potting compound can correspondingly completely compensate for any dimensional deviation (geometric manufacturing tolerances) of the ceramic flat filter.

CN 111 013 393 A shows a set comprising a flat ceramic membrane and an end cap arrangement, consisting of a water collecting cap and an elastic sealing sleeve which receives the ceramic membrane in a sealing manner.

CN 207 694 609 U describes a set comprising a flat ceramic membrane and a rigid end cap, in which the membrane is inserted on an elastic delimiting structure and is adhesively bonded to the end cap via an adhesive region.

Against this background, the present invention is based on the object of providing a sealing method together with the devices required for this purpose for ceramic flat filters, which is distinguished by better suitability for practice, in particular with regard to shorter production times (assembly time).

### SUMMARY

This object may be achieved by a set comprising a ceramic flat filter, a flexible end cap and an adhesive according to Claim 1, a flat filter with a flexible end cap according to Claim 9, a flexible end cap according to Claim 10 and a method for radially sealing a ceramic flat filter with a flexible end cap according to Claim 12.

The set comprises a ceramic flat filter, a flexible end cap and an adhesive. The flat filter has two axial end faces and radial side faces. In its interior, filtrate channels extend along the flat filter plane and open into at least one axial end face of the flat filter. The end cap is configured to be mounted on an end-face end region of the flat filter, is configured to be permanently fastened to the flat filter in the mounted state by means of the adhesive and has at least one filtrate outlet and a filtrate collection channel, wherein filtrate supplied from the filtrate channels of the flat filter is collectable in the filtrate collection channel in the mounted state and is forwardable to the at least one filtrate outlet. The end cap is formed from an elastic material and has a gap-shaped recess, wherein the recess, in an expanded state, can receive an insertion region of the flat filter and the recess, in a non-expanded state, has a clear width which is of the same size or of a smaller size with respect to the insertion region of the flat filter. In the mounted state, the insertion region of the flat filter is received in the recess of the end cap and the adhesive is introduced radially circumferentially between the radial side faces in the insertion region of the flat filter and the inner wall of the recess of the end cap. The end cap, in the mounted state, forms a radial seal with the adhesive between the inner wall of the recess and the radial side faces of the flat filter in the insertion region.

The clear width of the gap-shaped recess of the flexible end cap is of the same size or of a smaller size with respect to the insertion region of the flat filter. This means that-before the flat filter is inserted into the flexible end cap—the inner dimensions of the recess of the flexible end cap are in each case equal to or smaller than the corresponding outer dimensions of the insertion region of the flat filter both in terms of their longitudinal extent (that is to say the end cap inner width) and in terms of their transverse extent (that is to say the end cap inner thickness). In order to insert the insertion region of the filter into the recess, the recess must accordingly be expanded in the longitudinal and transverse extent.

After the filter has been inserted into the (expanded) recess, the flexible end cap can be elastically contracted again. Accordingly, in the mounted state, there is no open gap between the flat filter and the flexible end cap. Rather, the end cap (or the inner wall of the recess) bears radially circumferentially against the radial side faces of the flat filter.

In the mounted state, an adhesive is in this case located between the flexible end cap and the radial side faces of the flat filter in the insertion region. As a result of the synergistic interaction of the radially circumferential bearing of the end cap against the radial side faces of the flat filter and the adhesive action of the adhesive, the inner wall of the recess of the end cap seals against the radial side faces of the flat filter in the insertion region according to the radial sealing principle.

The adhesive furthermore enables the permanent fixing of the flexible end cap to the flat filter, in particular also during the backflushing phases. In this case, this adhesive does not have to flow gravitationally into a gap like the potting compound in the prior art, but rather can be introduced in any desired position. The need to wait for the inflow phase and the curing phase before a further end cap can be mounted on the opposite end face of the flat filter is therefore dispensed with. Embodiments of the invention therefore permit significantly shorter production times.

The adhesive is applied (for example in the form of an adhesive bead or in the form of adhesive dots) directly in the insertion region of the flat filter to the radial side faces thereof and/or to the inner wall of the recess of the end cap. In this case, the adhesive is typically applied with a thickness of 1 to 3 mm and distributed radially uniformly. In order to insert the flat filter into the end cap, the recess of the end cap—before or after the application of the adhesive—is expanded in terms of its longitudinal extent and its transverse extent (expansion of the end cap over its inner width and thickness).

This is expediently carried out by means of a spreading device (spreading tool) which is inserted into the recess of the flexible end cap and then expands (spreads) the latter with regard to the end cap inner width and the end cap inner thickness. The expansion of the recess of the end cap achieves an oversize in relation to the insertion region of the flat filter. This makes it possible that, when the flat filter is inserted into the recess, the inner wall of the recess and the applied adhesive bead are not in contact or are not “smeared”. As soon as the insertion region of the flat filter has been inserted completely into the expanded recess of the end cap (the insertion depth in this end position is advantageously between 5 and 15 mm in this case), the expansion is ended. The end cap then elastically contracts again, with the result that the inner wall of the recess of the end cap and the radial side faces of the flat filter come into contact in the insertion region.

As a result of the (non-expanded) recess of the end cap being of the same size or of a smaller size with respect to the flat filter, the applied adhesive (for example the adhesive bead) is squeezed and distributed uniformly in the contact region between inner wall of the recess and the radial side faces of the flat filter when the end cap elastically contracts again after the expansion has ended.

After the adhesive has cured, the end cap and the flat filter form a permanently firm unit which cannot be separated. The adhesive prevents the displacement or deformation of the end cap and therefore forms the required holding force on the inside in order to ensure the seal. As a result, an external, enclosing housing is not required for sealing.

According to a first preferred embodiment, the inner wall of the recess of the end cap has a projecting shoulder region, and, in the mounted state of the end cap, the shoulder region bears against an edge region of the axial end face of the insertion region of the flat filter or presses against the latter, with the result that the end cap forms an axial seal with respect to the flat filter in this edge region.

In this way, the seal between the ceramic flat filter and the end cap—in contrast to the customary sealing methods—is realized not only by radial sealing (with respect to the radial side faces of the flat filter) but also by axial sealing (with respect to the edge regions of the axial end face of the flat filter). A particularly permanent seal can therefore be made possible, in particular with regard to the pressure conditions occurring during the backflushing phases.

It can preferably be provided that the inner wall of the recess of the end cap has a circumferential recess for receiving adhesive. In this way, the mounting process can be made easier and more robust. This is because the recess serves firstly as a type of guide and therefore facilitates the uniform application of the adhesive. Secondly, the adhesive introduced into the recess (for example in the form of an adhesive bead) protrudes less far into the recess of the end cap, with the result that the risk of “smearing” of the adhesive during the insertion of the flat filter into the (expanded) recess of the end cap can be reduced further. This is beneficial to the process reliability, the longevity and the tightness of the seal.

Furthermore, the end cap is preferably formed from an elastic plastic of Shore hardness A in a range from 65 to 85 SHORE A, preferably from 70 to 80 SHORE A, and/or from a plastic from the group of EPDM (ethylene-propylene-diene rubbers), fluoroelastomers (in particular Viton), TPE (thermoplastic elastomers), or polyurethane. In this case, the Shore hardness A is determined in a customary manner with determination of the indentation hardness by means of a durometer, in particular according to DIN EN ISO 868:2003-10 or ASTM D2240.

The adhesive preferably comprises epoxy resin, polyurethane, silane-modified polymers or methacrylate and/or has a viscosity of at least 6000 mPas at a temperature of 25° C. (in a Brookfield RVT measurement or a cone-plate system measurement).

According to a further preferred embodiment of the invention, the clear width of the recess (of the end cap), in the non-expanded state, has an end cap inner width of between 70 and 290 mm and/or an end cap inner thickness of 1 to 6 mm, while the end side of the insertion region of the ceramic flat filter has an outer dimension width of 80 to 300 mm and/or an outer dimension thickness of 3 to 8 mm. In this way, an undersize of the recess in relation to the flat filter in relation to the width of 10 mm and in relation to the thickness of 2 mm can be achieved. This has proven to be a particularly practical compromise between ease of assembly and tightness.

For specific applications, it can be advantageous for an end cap having at least one filtrate outlet to be provided in each case on both end faces of the flat filter. In this way, the filtrate can be drawn off via both end faces of the flat filter. For this purpose, it is preferably provided that the filtrate channels of the flat filter extend along the flat filter plane and open into two axial end faces of the flat filter and the set comprises a second flexible end cap, wherein the second flexible end cap is of identical design to the first flexible end cap and, in the mounted state, the two end caps are mounted on opposite axial end faces of the flat filter.

For other applications, on the other hand, it can prove to be advantageous if only one of the two end caps has a filtrate outlet on the end faces of the flat filter. In this way, the filtrate can be drawn off only via that end face of the flat filter on which the end cap having (at least one) filtrate outlet is located. Here, the second end cap merely has a sealing function.

For this purpose, it is preferably provided that the filtrate channels of the flat filter extend along the flat filter plane and open into two axial end faces of the flat filter. The set comprises a second flexible end cap which is configured to be mounted on a second end-face end region of the flat filter and is configured to be permanently fastened to the flat filter in the mounted state by means of the adhesive and has a filtrate collection channel which, in the mounted state, communicates fluidically with the filtrate channels of the flat filter. The second end cap is formed from an elastic material and has a gap-shaped recess. The recess, in an expanded state, can receive a second insertion region of the flat filter and, in a non-expanded state, has a clear width which is of the same size or of a smaller size with respect to the second insertion region of the flat filter (and therefore prevents the second insertion region of the flat filter from being received). In the mounted state, the second insertion region of the flat filter is received in the recess of the second end cap and the adhesive is introduced radially circumferentially between the radial side faces in the second insertion region of the flat filter and the inner wall of the recess of the second end cap. The second end cap, in the mounted state, forms a radial seal with the adhesive between the inner wall of the recess and the radial side faces of the flat filter in the second insertion region.

The flat filter according to embodiments of the invention with flexible end cap in the mounted state is produced from a set according to the preceding embodiments.

The flexible end cap for use in a set according to the preceding embodiments is configured to be mounted on an end-face end region of a flat filter and is configured to be permanently fastened to the flat filter in the mounted state by means of an adhesive and has a filtrate collection channel (and optionally at least one filtrate outlet). The end cap is formed from an elastic material and has a gap-shaped recess, wherein the recess, in an expanded state, can receive an insertion region of a flat filter and the recess, in a non-expanded state, has a clear width which is of the same size or of a smaller size with respect to the insertion region of the same flat filter (and therefore prevents the insertion region of the flat filter from being received in the non-expanded state). The recess, in the non-expanded state, has a clear width which is at least 5 times greater, in particular at least 10 times greater, in its longitudinal extent than in its transverse extent.

In this case, the flexible end cap preferably has holding elements which are arranged on opposite sides of the recess. These allow simple (manual or mechanical) expansion of the recess in its longitudinal or transverse extent. In this case, the holding elements can be removed within the scope of the production process after the expansion process has ended.

Method comprising the following steps is used for radially sealing a ceramic flat filter with a flexible end cap:
A) providing a set according of a ceramic flat filter, a flexible end cap and an adhesive,
B) applying the adhesive radially circumferentially in the recess of the end cap and/or on the radial side faces of the flat filter in an insertion region of the flat filter,
C) expanding the recess of the flexible end cap in the longitudinal direction and in the transverse direction of the recess,
D) inserting the insertion region of the flat filter into the expanded recess of the end cap,
E) ending the expansion of the recess and, associated therewith, allowing the flexible end cap to be elastically contracted while forming a radial seal between the inner wall of the recess of the end cap and the radial side faces of the insertion region of the flat filter.

According to a preferred embodiment of the method according to the invention, in this case it is provided in step C) that the expansion of the recess of the flexible end cap in the longitudinal and/or transverse direction is carried out by pulling apart the end cap on holding elements attached to opposite sides of the recess, and/or that the expansion of the recess of the flexible end cap in the longitudinal and/or transverse direction of the recess is carried out by means of a spreading device engaging into the recess or acting thereon in some other suitable manner. In this case, in particular, a combination of the two abovementioned possibilities can also be envisaged, e.g. by the expansion of the recess of the end cap in a first direction from the longitudinal direction and transverse direction being carried out by pulling apart on correspondingly arranged holding elements, while in the second direction from the longitudinal direction and transverse direction, spreading apart is carried out by means of a spreading device engaging into the recess (or acting thereon in a suitable manner).

Furthermore, it can be provided in step D) that the insertion region of the flat filter is inserted into the expanded recess of the end cap by the flat filter being inserted until an end face of the flat filter abuts or is pressed against the end cap, wherein the end face of the flat filter in particular abuts against a projecting shoulder region of the inner wall of the recess of the end cap and/or is pressed against the shoulder region.

Furthermore, it can advantageously be provided in step D) that during the insertion of the insertion region of the flat filter into the expanded recess of the end cap, the adhesive applied radially circumferentially in the recess of the end cap does not come into contact with the flat filter, and/or the adhesive applied radially circumferentially on the radial side faces of the flat filter does not come into contact with the end cap.

According to a further preferred embodiment, it is provided that the method additionally comprises the following step:
F) radial pressing of the flexible end cap onto the flat filter.

The (manual or mechanical) pressing of the flexible end cap onto the flat filter promotes the contraction of the flexible end cap and, in addition, promotes the uniform distribution and “squeezing” of the adhesive in the contact region between the inner wall of the recess and the radial side faces of the flat filter.

### BRIEF DESCRIPTION OF THE DRAWING

Exemplary embodiments of the invention are explained in more detail below with reference to the drawing.

FIGS. 1A to 1B show a ceramic flat filter according to the prior art in an oblique view (FIG. 1A) and a front view (FIG. 1),

FIGS. 2A to 2C show a flat filter with a dimensionally stable (rigid) end cap with potting adhesive bond at various assembly stages according to the prior art,

FIGS. 3A to 3D show a first exemplary embodiment of a set according to the invention of flat filter, flexible end cap and adhesive at various assembly stages,

FIGS. 4A and 4B show two perspective views of a second exemplary embodiment of the set according to the invention with two end caps,

FIGS. 5A and 5B show two perspective views of the second exemplary embodiment of the set according to the invention, wherein an end cap is in the expanded state and, in FIG. 5A, the adhesive is applied to the flat filter and, in FIG. 5B, to the inner wall of the recess, and

FIGS. 6A and 6B show various views of a flexible end cap together with a spreading device engaging therein, wherein the end cap is illustrated in the non-expanded (closed) state (FIG. 6A) and in the expanded (spread) state (FIG. 6B).

### DETAILED DESCRIPTION OF THE PREFERRED EMBODIMENTS

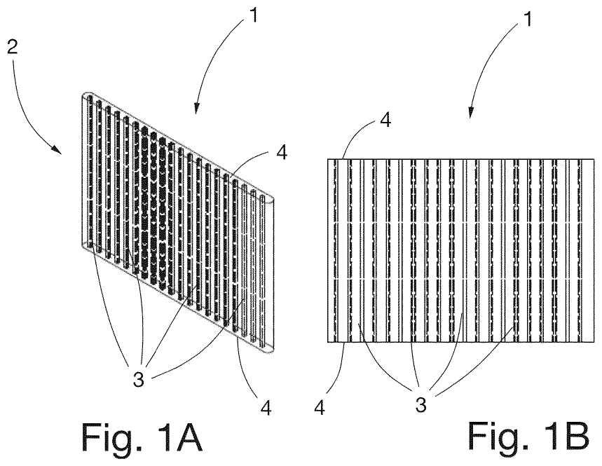

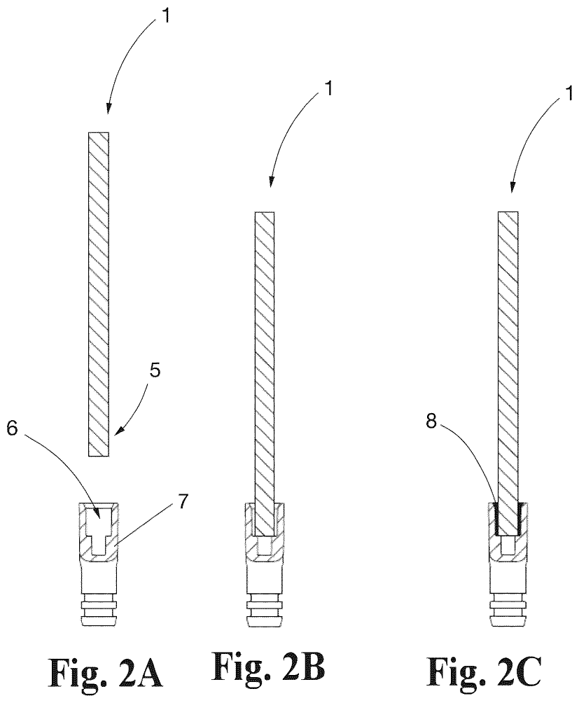

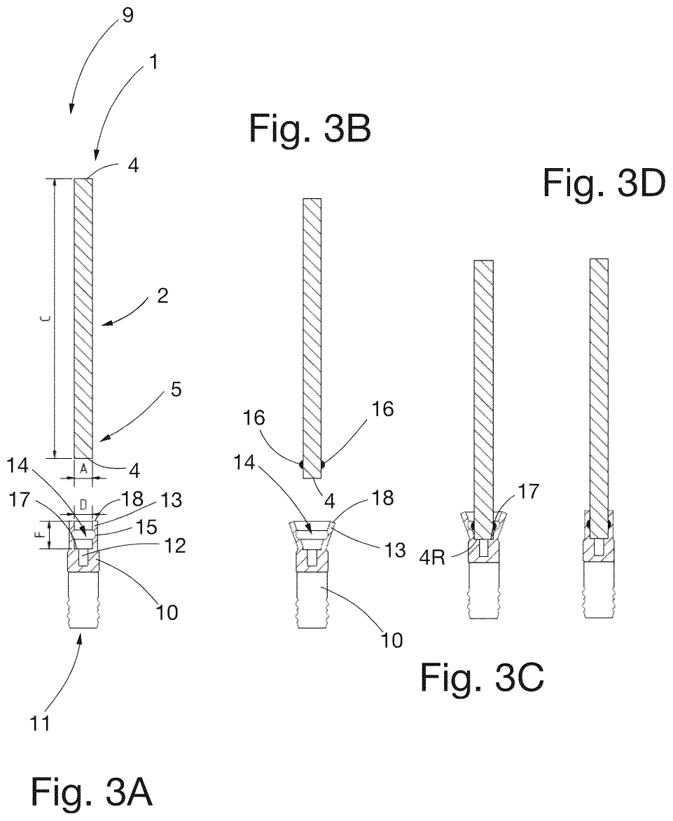

FIGS. 1A to 2C represent prior art and have already been discussed, whereas FIGS. 3A to 6B show the invention.

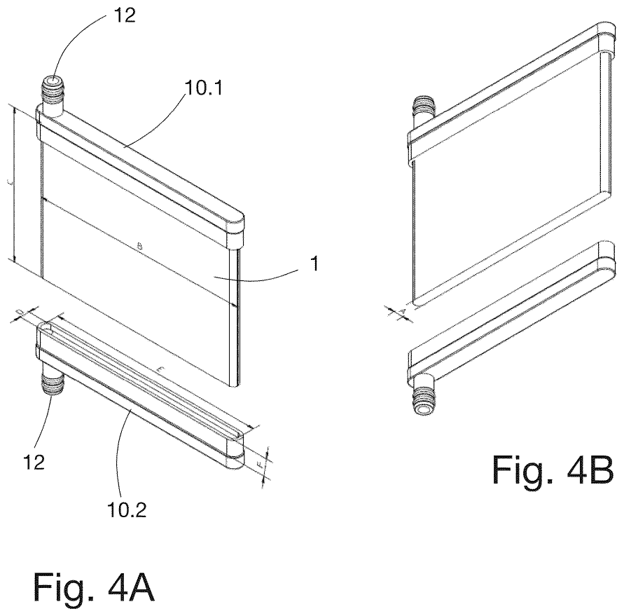

FIGS. 3A to 3D each represent the same first exemplary embodiment of a set 9 according to the invention, wherein different assembly states are shown in the individual figures. The ceramic flat filter 1 itself corresponds to the prior art acknowledged in conjunction with FIGS. 2A-C and has two axial end faces 4 which in each case extend over an (outer dimension) thickness A and (outer dimension) width B (see FIGS. 4A and 4B). The radial side faces 2 extend along the length C of the flat filter 1 (longitudinal extent of the filter). In the region of the lower end face 4, the flat filter 1 has an insertion region 5. In the interior of the filter 1, filtrate channels (not illustrated in FIGS. 3A to 3D) run along the flat filter plane and open into both axial end faces 4 of the flat filter 1.

The flexible end cap 10 is formed from an elastic material and has a filtrate outlet 11, a filtrate collection channel 12 and a gap-shaped recess 14 formed by a circumferential wall 13. A circumferential recess 15 in the form of a semicircular depression for receiving adhesive 16 is arranged on the inner side of the wall 13 of the recess 14 (inner wall of the recess) of the end cap, wherein the depression could of course also be shaped differently. The clear width of the recess 14, in the non-expanded state illustrated in FIG. 3A, has an end cap inner width E (see FIGS. 4A and 4B) and an end cap inner thickness D. In the non-expanded state, the clear width of the recess 14 is of the same size or of a smaller size with respect to the insertion region 5 of the flat filter 1. This means that the end cap inner width E is equal to or less than the width B of the flat filter 1 and that the end cap inner thickness D is equal to or less than the thickness A (of the flat filter 1). The inner wall of the recess 14 has a shoulder region 17 at its base. The insertion depth F is defined by the distance of the shoulder region 17 from the upper edge 18 of the wall 13 of the recess 14.

According to FIG. 3B, the recess 14 of the end cap 10 (by means of a spreading device (not illustrated)) has been moved into the expanded state. In this case, the wall 13 is moved radially outward to a greater extent in the region of its upper edge 17 than in the region of the base of the recess 14, with the result that the recess 14 assumes a funnel-shaped form. In this expanded state, the clear width of the recess 14 in the region of the upper edge 17 of the recess 14 is of a larger size with respect to the insertion region 5 of the flat filter 1. Adhesive 16 in the form of an adhesive bead has been applied to the radial side faces 2 of the flat filter.

FIG. 3C shows a (inserted) flat filter 1 inserted into the end cap 10 as far as the end position. The shoulder region 17 of the end cap 10 bears against an edge region 4R of the axial end face 4 of the insertion region 5 of the flat filter 1. The flat filter 1 is inserted in the expanded state of the end cap 10. In this way, the insertion region 5 of the flat filter can be inserted quickly and easily into the end cap 10 without the radial side faces 2 of the flat filter 1 (or the adhesive 16) coming into contact with the inner wall of the recess 14.

The expansion of the recess 14 of the end cap 10 is then ended. The end cap 10 in particular the recess 14 elastically contracts again and assumes the form illustrated in FIG. 3D. The wall 13 of the recess 14 bears radially circumferentially in the insertion region 5 of the flat filter 1, and the (squashed) adhesive 16 is located between the wall 13 and the flat filter 1 and, after it has cured, permanently fixes the end cap 10 to the flat filter 1.

In this mounted state, the end cap 10 forms a radial seal with the adhesive 16 (after curing) between the inner wall of the recess 14 and the radial side faces 2 of the flat filter 1 in the insertion region 5. The shoulder region 17 of the end cap 10 bears against an edge region 4R of the axial end face 4 of the flat filter 1 and forms an axial seal with respect to the flat filter 1 there. Filtrate supplied from the filtrate channels 3 of the flat filter 1 is collectable in the filtrate collection channel 12 and is forwardable to the filtrate outlet 11.

The second exemplary embodiment of the invention illustrated in FIGS. 4A and 4B has not just one but two flexible end caps 10.1, 10.2 with in each case one filtrate outlet 12. Filtrate can therefore be drawn off from the ceramic flat filter 1 via both filtrate outlets 12. The upper end cap 10.1 is in the mounted state, and the lower end cap 10.2 is in the non-mounted, non-expanded state. It can be seen in the perspective illustrations that the ceramic flat filter 1 has the shape of a plate with rounded edges. The recesses of the end caps 10.1, 10.2 are shaped in a corresponding manner in order to promote (in the mounted state) a radially circumferential bearing of the wall 13 against the radial side faces 2 of the flat filter 1.

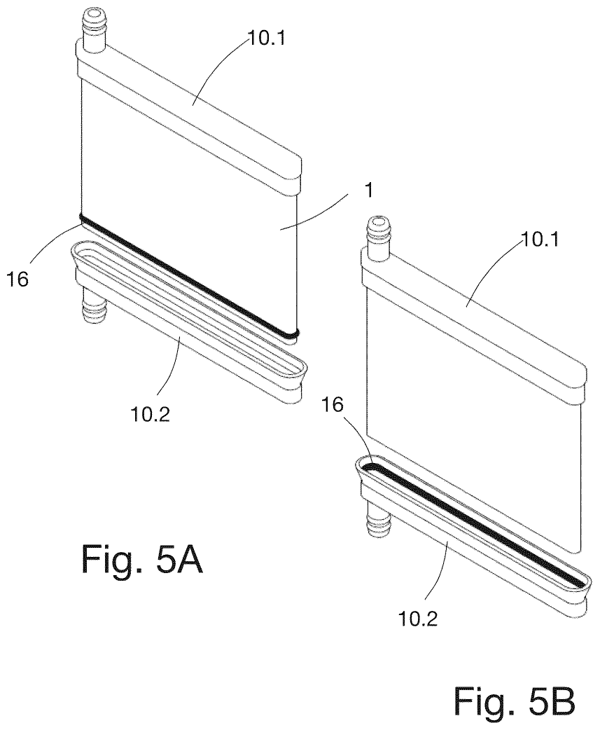

FIGS. 5A and 5B each show the second exemplary embodiment according to FIGS. 4A and 4B, but the lower end cap 10.2 is now in the expanded state. Two different possibilities of applying the adhesive 16 are illustrated. According to FIG. 5A, the adhesive 16 (in the form of an adhesive bead) was applied radially circumferentially on the radial side faces 2 of the flat filter 1 (in an insertion region 5 of the flat filter 1). In FIG. 5B, on the other hand, the adhesive 16 (in the form of an adhesive bead) was applied radially circumferentially in a circumferential recess 15 of the inner wall of the recess 14 of the (lower) end cap 10.2.

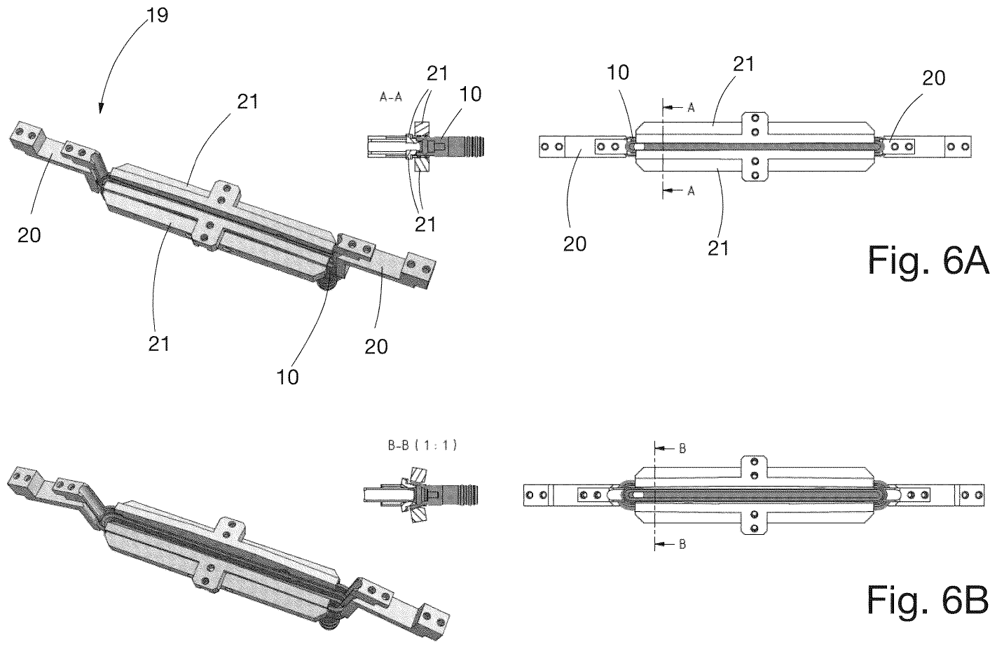

FIGS. 6A and 6B illustrate a possibility of expanding the recess 14 of the flexible end cap 10 by means of a spreading device 19 (spreading tool). For this purpose, the spreading device 19 has two pairs of lever plates 20, 21. The width lever plates 20 allow expansion (spreading) of the recess 14 with regard to its width, and the thickness lever plates 21 allow expansion of the recess 14 with regard to its thickness. For this purpose, the lever plates 20, 21 are first of all inserted into the recess 14 as illustrated in FIG. 6A and then simultaneously tilted outward. As shown in FIG. 6B, this is accompanied by radial expansion of the wall 13 of the recess 14, with the result that the recess 14 is moved into the expanded state.

What is claimed is:

1. A set (9) of a ceramic flat filter (1), a flexible end cap (10) and an adhesive (16), wherein:
the flat filter (1) has two axial end faces (4) and radial side faces (2) and, in its interior, filtrate channels (3) extend along the flat filter plane and open into at least one axial end face (4) of the flat filter (1),
the end cap (10) is configured to be mounted on an end-face end region of the flat filter (1) and is configured to be permanently fastened to the flat filter (1) in the mounted state by means of the adhesive (16) and has at least one filtrate outlet (11) and a filtrate collection channel (12), wherein filtrate supplied from the filtrate channels (3) of the flat filter (1) is collectable in the filtrate collection channel (12) in the mounted state and is forwardable to the at least one filtrate outlet (11),
the end cap (10) is formed from an elastic material and has a gap-shaped recess (14), wherein the recess (14), in an expanded state, can receive an insertion region (5) of the flat filter (1) and the recess (14), in a non-expanded state, has a clear width which is of the same size or of a smaller size with respect to the insertion region (5) of the flat filter (1),
in the mounted state, the insertion region (5) of the flat filter (1) is received in the recess (14) of the end cap (10) and the adhesive (16) is introduced radially circumferentially between the radial side faces (2) in the insertion region (5) of the flat filter (1) and the inner wall of the recess (14) of the end cap (10), and
the end cap (10), in the mounted state, forms a radial seal with the adhesive (16) between the inner wall of the recess (14) and the radial side faces (2) of the flat filter (1) in the insertion region (5).

2. The set of claim 1, wherein:
the inner wall of the recess (14) of the end cap (10) has a projecting shoulder region (17), and
the shoulder region (17), in the mounted state of the end cap (10), bears against an edge region (4R) of the axial end face (4) of the insertion region (5) of the flat filter (1) or is pressed against the latter, such that the end cap (10) forms an axial seal with respect to the flat filter (1) in this edge region (4R).

3. The set of claim 1, wherein:
the inner wall of the recess (14) of the end cap (10) has a circumferential recess (15) for receiving adhesive (16).

4. The set of claim 1, wherein:
the end cap (10) is formed from an elastic plastic of Shore hardness A in a range from 65 to 85 SHORE A, preferably from 70 to 80 SHORE A, and/or from a plastic from the group of EPDM, fluoroelastomers, in particular Viton, TPE or polyurethane.

5. The set of claim 1, wherein the adhesive:
comprises epoxy resin, polyurethane, silane-modified polymers or methacrylate and/or
has a viscosity of at least 6000 mPas at a temperature of 25° C.

6. The set of claim 1, wherein:
the clear width of the recess (14), in the non-expanded state, has an end cap inner width (E) of between 70 and 290 mm and/or an end cap inner thickness (D) of 1 to 6 mm, and
the end face (4) of the insertion region (5) of the ceramic flat filter (1) has an outer dimension width (B) of 80 to 300 mm and/or an outer dimension thickness (A) of 3 to 8 mm.

7. The set of claim 1, wherein:
the filtrate channels (3) of the flat filter (1) extend along the flat filter plane and open into two axial end faces (4) of the flat filter (1),
the set (9) comprises a second flexible end cap (10), wherein the second flexible end cap (10) is of identical design to the first flexible end cap (10) and, in the mounted state, the two end caps are mounted on opposite axial end faces (4) of the flat filter (1).

8. The set of claim 1, wherein:
the filtrate channels (3) of the flat filter (1) extend along the flat filter plane and open into two axial end faces (4) of the flat filter (1),
the set (9) comprises a second flexible end cap (10),
the second end cap (10) is configured to be mounted on a second end-face end region of the flat filter (1) and is configured to be permanently fastened to the flat filter (1) in the mounted state by means of the adhesive (16) and has a filtrate collection channel (12) which, in the mounted state, communicates fluidically with the filtrate channels (3) of the flat filter (1),
the second end cap (10) is formed from an elastic material and has a gap-shaped recess (14), wherein the recess (14), in an expanded state, can receive a second insertion region (5) of the flat filter (1) and the recess (14), in a non-expanded state, has a clear width which is of the same size or of a smaller size with respect to the second insertion region (5) of the flat filter (1),
in the mounted state, the second insertion region (5) of the flat filter (1) is received in the recess (14) of the second end cap (10) and the adhesive (16) is introduced radially circumferentially between the radial side faces (2) in the second insertion region (5) of the flat filter (1) and the inner wall of the recess (14) of the second end cap (10), and
the second end cap (10), in the mounted state, forms a radial seal with the adhesive (16) between the inner wall of the recess (14) and the radial side faces (2) of the flat filter (1) in the second insertion region (5).

9. A flat filter (1) with flexible end cap (10) in the mounted state, produced from the set of claim 1.

10. A flexible end cap (10) for use in the set of claim 1, wherein:
the end cap (10) is configured to be mounted on an end-face end region of a flat filter (1) and is configured to be permanently fastened to the flat filter (1) in the mounted state by means of an adhesive (16) and has a filtrate collection channel (12),
the end cap (10) is formed from an elastic material and has a gap-shaped recess (14), wherein the recess (14), in an expanded state, can receive an insertion region (5) of a flat filter (1) and the recess (14), in a non-expanded state, has a clear width which is of the same size or of a smaller size with respect to the insertion region (5) of the same flat filter (1),
the recess (14), in the non-expanded state, has a clear width which is at least 5 times greater, in particular at least 10 times greater, in its longitudinal extent than in its transverse extent.

11. The flexible end cap of claim 10, wherein:
the end cap (10) has holding elements which are arranged on opposite sides of the recess (14).

12. A method for radially sealing a ceramic flat filter (1) with a flexible end cap (10), comprising the following steps:
A) providing the set (9) of a ceramic flat filter (1), a flexible end cap (10) and an adhesive (16) according to claim 1,
B) applying the adhesive (16) radially circumferentially in the recess (14) of the end cap (10) and/or on the radial side faces (2) of the flat filter (1) in an insertion region (5) of the flat filter (1),
C) expanding the recess (14) of the flexible end cap (10) in the longitudinal direction and in the transverse direction of the recess (14),
D) inserting the insertion region (5) of the flat filter (1) into the expanded recess (14) of the end cap (10),
E) ending the expansion of the recess (14) and, associated therewith, allowing the flexible end cap (10) to be elastically contracted while forming a radial seal between the inner wall of the recess (14) of the end cap (10) and the radial side faces (2) of the insertion region (5) of the flat filter (1).

13. The method of claim 12, wherein in step C:
the expansion of the recess (14) of the flexible end cap (10) in the longitudinal direction and/or in the transverse direction is carried out by pulling apart the end cap (10) on holding elements attached to opposite sides of the recess (14), and/or
the expansion of the recess (14) of the flexible end cap (10) in the longitudinal direction and/or transverse direction of the recess (14) is carried out by means of a spreading device (19) engaging into the recess or acting thereon.

14. The method of claim 12, wherein in step D:
the insertion region (5) of the flat filter (1) is inserted into the expanded recess (14) of the end cap (10) by the flat filter (1) being inserted until an end face (4) of the flat filter (1) abuts or is pressed against the end cap (10), wherein the end face (4) of the flat filter (1) in particular abuts against a projecting shoulder region (17) of the inner wall of the recess (14) of the end cap and/or is pressed against the shoulder region (17).

15. The method of claim 12, wherein in step D, during the insertion of the insertion region (5) of the flat filter (1) into the expanded recess of the end cap (10):
the adhesive (16) applied radially circumferentially in the recess (14) of the end cap (10) does not come into contact with the flat filter (1), and/or
the adhesive (16) applied radially circumferentially on the radial side faces (2) of the flat filter (1) does not come into contact with the end cap (10).

16. The method of claim 12, wherein the method further comprises the following step:
F) radial pressing of the flexible end cap (10) onto the flat filter (1).
